(19) United States
(12) Patent Application Publication
(10) Pub. No.: US 2013/0043013 A1
(43) Pub. Date: Feb. 21, 2013

(54) Heat Exchanger and Method for Producing Heat Exchanger

(71) Applicants: Yusuke Iino, Isesaki-shi (JP); Yuuichi Matsumoto, Isesaki-shi (JP)

(72) Inventors: Yusuke Iino, Isesaki-shi (JP); Yuuichi Matsumoto, Isesaki-shi (JP)

(21) Appl. No.: 13/643,938

(22) PCT Filed: Apr. 15, 2011
(86) PCT No.: PCT/JP2011/059434

§ 371 Date: Oct. 26, 2012

(30) Foreign Application Priority Data
Apr. 27, 2010 (JP) 2010-101940

(51) Int. Cl. F28F 1/12; B23P 15/26

(52) U.S. Cl. 165/181; 29/890.054

(57) ABSTRACT

The present invention relates to a heat exchanger capable of maintaining adhesion between fins and a heat exchange tube while achieving corrosion protection of the heat exchange tube, and a method for producing the heat exchanger. In the heat exchanger which includes a heat exchange tube 4 and a plate-like fin 5 having a through-hole 5a through which the heat exchange tube 4 passes, the plate-like fin 5 has a three-layer structure including a core material layer 52 formed of an Al—Mn based alloy, a brazing material layer 51 that constitutes one end surface and is formed of an Al—Si based alloy, and a sacrificial corrosion layer 53 that constitutes the other end surface and is formed of an Al—Zn—Mg based alloy, and has a tubular portion 5b which is raised from a periphery of the through-hole 5a and uses the brazing material layer 51 as an inner peripheral surface. In addition, a plurality of the plate-like fins 5 which are stacked at the heat exchange tube 4 are joined to the heat exchange tube 4 by brazing through fusing of the brazing material layer 51.

### TECHNICAL FIELD

The present invention relates to a heat exchanger that includes a heat exchange tube and a plurality of plate-like fins each having a through-hole through which the heat exchange tube passes, and a method for producing the heat exchanger.

### BACKGROUND ART

Hitherto, there has been known a heat exchanger in which a through-hole through which a heat exchange tube passes is formed in a plate-like fin, a tubular portion which is raised from the periphery of the through-hole is provided, a plurality of the abovementioned plate-like fins are stacked at the heat exchange tube, and thereafter, the tubular portion of the plate-like fin and the heat exchange tube are caused to come into close contact with each other by expanding the diameter of the heat exchange tube, and a sacrificial corrosion layer is further provided on the outside of the tubular portion so as to suppress the corrosion of the inside layer of the tubular portion that is connected to the heat exchange tube (refer to Patent Document 1).

In addition, as a technique for enhancing the corrosion resistance of a heat exchange tube, there has been known a technique in which a flux layer that contains a silicon Si powder and a zinc Zn-containing flux is formed on the outer surface of the heat exchange tube made of an aluminum alloy, each corrugated fin is interposed between and assembled to the heat exchange tubes, the fin is brazed to the heat exchange tubes by heating the assembled body, and zinc Zn in the flux is diffused in a brazing liquid and spreads on the surface of the heat exchange tubes during the brazing so as to enhance the corrosion resistance of the heat exchange tubes due to a sacrificial corrosion effect of the zinc Zn that spreads on the surface of the heat exchange tubes (refer to Patent Document 2).

### CITATION LIST

### Patent Document

[Patent Document 1] Japanese Laid-Open Patent Publication No. 2009-250510

[Patent Document 2] Japanese Laid-Open Patent Publication No. 2009-249728

### DISCLOSURE OF THE INVENTION

### Problems to be Solved by the Invention

However, as in Patent Document 1, in a case in which the plate-like fins each having the tubular portions that are raised from the peripheries of the through-holes are stacked and the tubular portion of the plate-like fin and the heat exchange tube are caused to come into close contact with each other by widening the diameter of the heat exchange tube, for example, a condensate that permeates from the gap between the adjacent tubular portions may adhere to the surface of the heat exchange tube. Therefore, even though the difference between the corrosion potentials (the difference between the spontaneous potentials) of the heat exchange tube and the inside layer of the tubular portion that comes in close contact with the heat exchange tube is set to be great, the corrosion of the heat exchange tube is not be able to be sufficiently prevented, and there is a possibility that the adhesion between the heat exchange tube and the plate-like fin may be degraded.

In addition, as in Patent Document 2, when the surface of the heat exchange tube is covered with the sacrificial corrosion layer, the sacrificial corrosion layer on the outside is sacrificially corroded and thus the corrosion of the inside of the heat exchange tube is able to be suppressed. However, since the fin is joined to the heat exchange tube via the sacrificial corrosion layer, when the sacrificial corrosion layer is corroded, there is a problem in that the fin falls or the adhesion between the fin and the heat exchange tube is degraded.

Therefore, an object of the present invention is to provide a heat exchanger capable of maintaining the adhesion between a fin and a heat exchange tube while achieving corrosion protection of the heat exchange tube, and a method for producing the heat exchanger.

### Means for Solving the Problems

In order to accomplish the object, there is provided a heat exchanger according to an embodiment of the present invention including: a heat exchange tube; and a plate-like fin having a through-hole through which the heat exchange tube passes, in which the plate-like fin has a multi-layer structure including at least a core material layer and a brazing material layer that constitutes one end surface, and has a tubular portion which is raised from a periphery of the through-hole and uses the brazing material layer as an inner peripheral surface, and a plurality of the plate-like fins which are stacked at the heat exchange tube are joined to the heat exchange tube by brazing with the brazing material layer.

In this configuration, since the inner peripheral surface of the tubular portion of the plate-like fin is constituted by the brazing material layer and the plate-like fins are brazed to the heat exchange tube with the brazing material layer, the outer surface of the heat exchange tube is covered with the brazing material layer and the brazing material layer that covers the outer surface of the heat exchange tube is covered with other layers (including the core layer) that constitute the plate-like fin.

Here, it is preferable that the plate-like fin has a multi-layer structure including the core material layer, the brazing material layer, and a sacrificial corrosion layer that constitutes the other end surface.

In this configuration, the brazing material layer that covers the outer surface of the heat exchange tube is covered with the core material layer and the sacrificial corrosion layer, and thus the sacrificial corrosion layer on the outside is sacrificially corroded.

In addition, among the core material layer, the brazing material layer, and the sacrificial corrosion layer which constitute the plate-like fin, preferably a corrosion potential of a metal that forms the sacrificial corrosion layer is the lowest, and a corrosion potential of a metal that forms the core material layer is the highest.

In this configuration, since the corrosion potential (spontaneous potential) of the metal that forms the sacrificial corrosion layer is the lowest, the sacrificial corrosion layer is the easiest to be corroded. On the other hand, since the corrosion potential (spontaneous potential) of the metal that forms the core material layer is the highest, the core material layer is the most difficult to be corroded, and the brazing material layer is sacrificially corroded subsequently to the sacrificial corrosion layer, thereby suppressing the corrosion of the core material layer.

In addition, the sacrificial corrosion layer may be formed of an aluminum-zinc-magnesium (Al—Zn—Mg) based alloy, the core material layer may be formed of an aluminum-manganese (Al—Mn) based alloy, the brazing material layer may be formed of an aluminum-silicon (Al—Si) based alloy, and the heat exchange tube may be formed of aluminum Al. In addition, the heat exchange tube may be formed of aluminum Al to which copper Cu is added or an aluminum-manganese (Al—Mn) based alloy.

In addition, the heat exchange tube may have a flat cross-sectional shape.

In this configuration, fixing and adhesion of the heat exchange tube having the flat cross-sectional shape to the plate-like fin by tube expansion are difficult, and thus, the plate-like fin is joined to the heat exchange tube by brazing.

On the other hand, according to the embodiment of the present invention, there is provided a method for producing a heat exchanger which includes an exchange tube and a plate-like fin having a through-hole through which the heat exchange tube passes, the method including the steps of: preparing, as the plate-like fin, a plurality of the plate-like fins, each having a multi-layer structure including at least a core material layer and a brazing material layer that constitutes one end surface thereof and each having a tubular portion which is raised from a periphery of the through-hole and uses the brazing material layer as an inner peripheral surface; stacking the plurality of the plate-like fins by causing the heat exchange tube to be inserted therethrough so as to cause the tubular portion to cover the heat exchange tube; and brazing the plurality of the plate-like fins to the heat exchange tube by fusing the brazing material layer.

In this configuration, when the heat exchange tubes are inserted into the through-holes of the plate-like fins, so that the plate-like fins are stacked, the tubular portions that are raised from the peripheries of the through-holes cover the outer periphery of the heat exchange tube. In addition, since the inner peripheral surface of the tubular portion is constituted by the brazing material layer, when the brazing material layers of the tubular portions are fused after the plate-like fins are stacked at the heat exchange tube, the plurality of the plate-like fins are brazed to the heat exchange tube. In addition, the outer surface of the heat exchange tube is covered with the brazing material layer by fusing the brazing material layer of the tubular portion. Moreover, the outside of the brazing material layer that covers the outer surface of the heat exchange tube is covered with other layers (including the core material layer) that constitute the plate-like fin.

Here, the step of preparing the plate-like fin may include a step of forming the tubular portion by a burring process.

In addition, in the step of preparing the plate-like fins, a plurality of the plate-like fins which have a multi-layer structure including the core material layer, the brazing material layer, and a sacrificial corrosion layer that constitutes the other end surface may be prepared.

In this configuration, the brazing material layer that covers the outer surface of the heat exchange tube is covered with the core material layer and the sacrificial corrosion layer, and the sacrificial corrosion layer on the outside is sacrificially corroded.

### ADVANTAGEOUS EFFECTS OF THE INVENTION

An aspect of the present invention provides a heat exchanger in which the outer periphery of the heat exchange tube is covered with the brazing material layer for brazing the plate-like fins to the heat exchange tube, and the brazing material layer that covers the heat exchange tube is covered with other layers that constitute the plate-like fin, and therefore, the corrosion resistance of the heat exchange tube is enhanced, and a reduction in the thickness of the heat exchange tube is achieved. In addition, the brazing material layer is protected from corrosion, and thus the adhesion between the plate-like fins and the heat exchange tube may be maintained.

In addition, an aspect of the present invention provides the method for producing a heat exchanger. Since the inner peripheral surface of the tubular portion of the plate-like fin is constituted by the brazing material layer, a brazing layer for brazing the plate-like fin to the heat exchange tube may be provided by causing the heat exchange tube to pass through the tubular portion. In addition, by fusing the brazing layer, the plate-like fin may be easily joined to the heat exchange tube. In addition, by fusing the brazing layer, the outer periphery of the heat exchange tubes is covered with the brazing material layer, and accordingly the corrosion of the heat exchange tube is suppressed. Moreover, since the brazing material layer that covers the heat exchange tube is covered with other layers that constitute the plate-like fin, the corrosion of the brazing material layer is able to be suppressed, and the adhesion between the plate-like fins and the heat exchange tube is able to be maintained.

### BRIEF DESCRIPTION OF THE DRAWINGS

FIG. 1 is a front view illustrating a heat exchanger according to an embodiment of the present invention;

FIG. 2 is a partial enlarged perspective view illustrating an assembled state of a heat exchange tube and a plate-like fin in the embodiment of the present invention;

FIG. 3 is a view illustrating the plate-like fin in the embodiment of the present invention, in which FIG. 3A is a front view, and FIG. 3B is a side view;

FIG. 4 is a cross-sectional view illustrating an assembled state of the heat exchange tube and the plate-like fin in the embodiment of the present invention;

FIG. 5 is a view illustrating a production process of the heat exchanger in the embodiment of the present invention;

FIG. 6 is a cross-sectional view illustrating a stacked state of the plate-like fins before brazing in the embodiment of the present invention; and

FIG. 7 is a cross-sectional view illustrating a stacked state of the plate-like fins after the brazing in the embodiment of the present invention.

### DESCRIPTION OF EMBODIMENTS

Hereinafter, embodiments of the present invention will be described in detail with reference to the accompanying drawings.

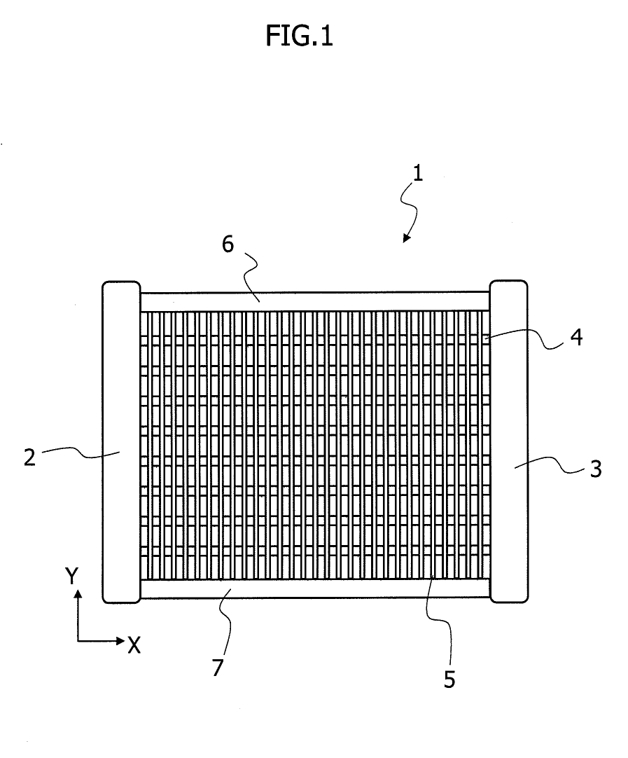

FIG. 1 is a front view illustrating the entirety of a heat exchanger 1 according to an embodiment of the present invention, and the heat exchanger 1 may be used in, for example, a heat pump-type air-conditioner for a vehicle.

The heat exchanger 1 includes: a pair of header tanks (header pipes) 2 and 3 which are arranged to oppose each other; a plurality of heat exchange tubes 4 which are arranged at intervals in parallel so as to connect the header tanks 2 and 3 to each other; a plurality of plate-like fins 5 which are arranged at intervals in parallel to traverse the plurality of heat exchange tubes 4; and side plates 6 and 7 which are provided at the upper end and the lower end of the plurality of plate-like fins 5.

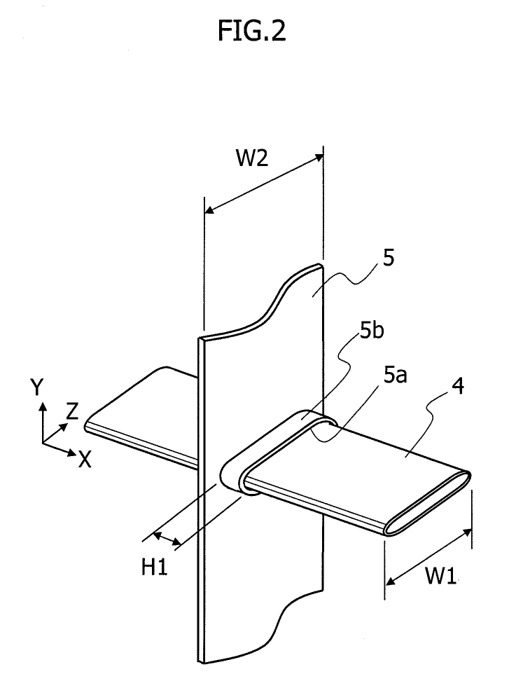

The heat exchange tube 4 is formed by, for example, extrusion using pure aluminum Al such as JISA1050, a material in which a small amount of copper Cu is added to pure aluminum Al, an aluminum-manganese (Al—Mn) based alloy such as JISA3003, or the like. As illustrated in FIG. 2, the cross-sectional shape of the heat exchange tube 4 is formed to be long and flat in a direction (Z-axis direction) that is orthogonal to the extending direction (X-axis direction) of the heat exchange tube 4 and is orthogonal to the extending direction (Y-axis direction) of the plate-like fins 5, such that a heat exchange medium is circulated through the internal space thereof.

Here, inner fins may be inserted into the internal space of the heat exchange tube 4, or the internal space of the heat exchange tube 4 may be divided into independent medium passages.

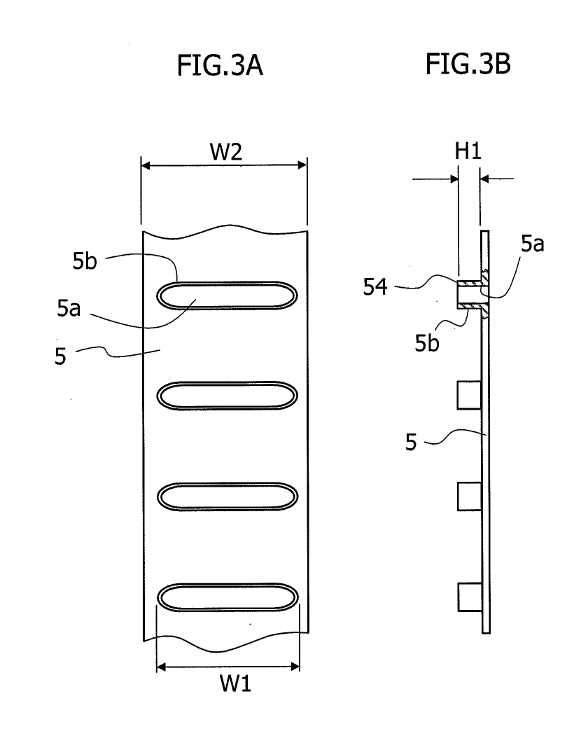

As illustrated in FIGS. 2 to 4, the plate-like fins 5 are formed in a rectangular shape having a width W2 that is greater than a width W1 in the longitudinal direction of a cross section of the heat exchange tube 4, and the length of the plate-like fins 5 is set to a length that traverses all the heat exchange tubes 4.

In addition, in the plate-like fin 5, a plurality of through-holes 5a through which the heat exchange tubes 4 passes are formed at the center in the width direction according to the arrangement of the heat exchange tubes 4. The through-hole 5a is set to a size into which the heat exchange tube 4 is able to be inserted with a play in a range in which brazing described later is able to be performed.

Moreover, the plate-like fin 5 is integrally provided with tubular portions 5b which are raised from the peripheries of the through-holes 5a. Accordingly, when the plurality of plate-like fins 5 are stacked by causing the heat exchange tube 4 to pass through the through-holes 5a, an annular end surface 54 at the front end of the tubular portion 5b abuts on the peripheral edge of the opening end of the through-hole 5a of the adjacent plate-like fin 5, and thus the plate-like fins 5 are stacked at the heat exchange tube 4 at an interval of the raised height H1 of the tubular portion 5b.

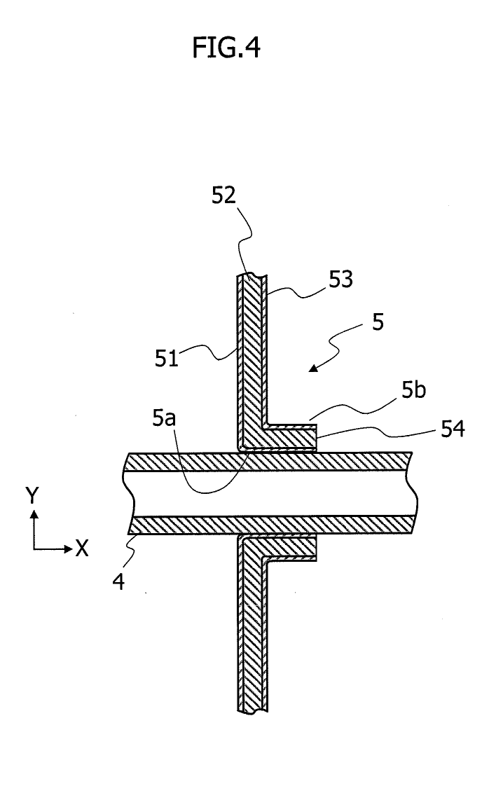

In addition, the plate-like fin 5 has a three-layer structure as illustrated in FIG. 4. The three-layer structure of the plate-like fin 5 includes: a brazing material layer 51 which functions as a brazing filler metal when the plate-like fin 5 is brazed to the heat exchange tube 4; a core material layer 52 which constitutes the main body part of the plate-like fin 5; and a sacrificial corrosion layer 53 which has a sacrificial corrosion protection effect of suppressing corrosion of other layers by being corroded sacrificially. The brazing material layer 51 constitutes one end surface of the plate-like fin 5, the sacrificial corrosion layer 53 constitutes the other end surface of the plate-like fin 5, and the core material layer 52 is interposed between the brazing material layer 51 and the sacrificial corrosion layer 53, thereby forming the plate-like fin 5.

The brazing material layer 51 is formed of an aluminum-silicon (Al—Si) based alloy such as JIS4343, JIS4032, JIS4043, or JIS4045, the core material layer 52 is formed of an aluminum-manganese (Al—Mn) based alloy such as JIS3003 or JIS3203, and the sacrificial corrosion layer 53 is formed of an aluminum-zinc-magnesium (Al—Zn—Mg) based alloy such as JIS7072.

Regarding selection of the metal materials that form the brazing material layer 51, the core material layer 52, and the sacrificial corrosion layer 53, there is the following relationship of the corrosion potential (spontaneous potential): “the corrosion potential of the metal that forms the sacrificial corrosion layer 53”<“the corrosion potential of the metal that forms the brazing material layer 51”<“the corrosion potential of the metal that forms the core material layer 52”. Therefore, the sacrificial corrosion layer 53 is the easiest to be corroded, and the core material layer 52 is the most difficult to be corroded.

In addition, as the metal that constitutes the brazing material layer 51, a metal having a melting point lower than those of the metals of the core material layer 52, the sacrificial corrosion layer 53, and the heat exchange tube 4, is used.

The levels of the corrosion potentials (the order of ease of corrosion) of the metal materials that form the brazing material layer 51, the core material layer 52, and the sacrificial corrosion layer 53 are in the above-described order, and the metal materials are not limited to the exemplified aluminum alloys as long as the metal materials are able to be brazed.

In addition, the core material layer 52 may be configured of a plurality of layers having different metal materials (different corrosion potentials). Therefore, the plate-like fin 5 is not limited to the three-layer structure and may have a multi-layer structure including four or more layers. Also in a case in which the core material layer 52 is configured of a plurality of layers, the corrosion potential of the metal that constitutes each of the layers is preferably higher than the corrosion potentials of the metals that constitute the sacrificial corrosion layer 53 and the brazing material layer 51.

Prepared holes of the through-holes 5a are formed by punching or the like and thereafter a burring process (raising process) is performed thereon, so that the tubular portions 5b of the plate-like fin 5 are formed integrally with the plate-like fin 5. Here, during the burring process in which the tubular portions 5b are formed, a processing direction is set so that the inner peripheral surface of the tubular portion 5b is constituted by the brazing material layer 51 and the outer peripheral surface of the tubular portion 5b is constituted by the sacrificial corrosion layer 53. In addition, the plate-like fin 5 is joined to the heat exchange tube 4 that passes through the tubular portion 5b by brazing by fusing of the brazing material layer 51 that constitutes the inner peripheral surface of the tubular portion 5b.

A flange portion having an outside diameter greater than that of the tubular portion 5b may be formed integrally with the front end portion of the opening of the tubular portion 5b.

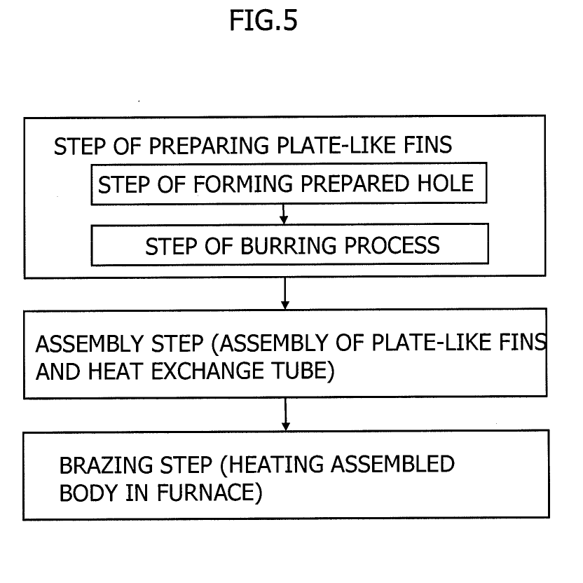

Next, a method for producing the heat exchanger 1 having the above configuration will be schematically described with reference to FIG. 5.

First, as a first step, components such as the plate-like fins 5, each of which includes the through-holes 5a and the tubular portions 5b and has the three-layer structure of the brazing material layer 51, the core material layer 52, and the sacrificial corrosion layer 53, the header tanks 2 and 3, the heat exchange tubes 4, and the side plates 6 and 7 are prepared.

The step of preparing the plate-like fins 5 includes a step of forming the prepared hole of the through-hole 5a by punching or the like and a step of forming the tubular portion 5b by a burring process.

When the components are prepared, assembly thereof is then performed.

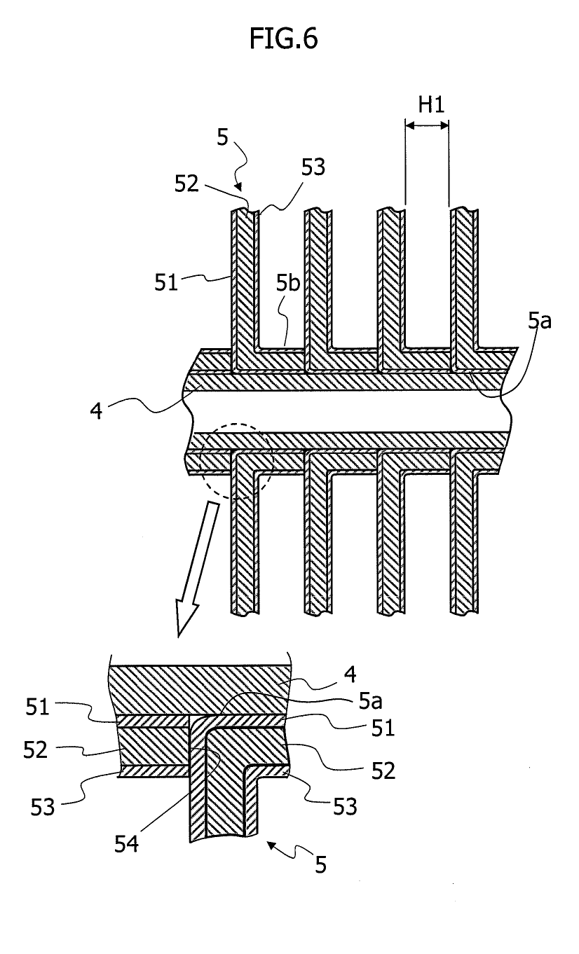

During assembly, the heat exchange tube 4 is inserted into the through-holes 5a of the plate-like fins 5, and the plurality of plate-like fins 5 are stacked at the heat exchange tube 4 so that the tubular portions 5b are directed in a predetermined direction. By this assembly, as illustrated in FIG. 6, the plurality of plate-like fins 5 are stacked in parallel with each other at intervals of the height H1 of the raised portion of the tubular portion 5b, and the outer periphery of the heat exchange tube 4 is covered with the plurality of tubular portions 5b.

When the assembly is completed, the assembled body is put into a furnace in which brazing is performed and is heated at up to, for example, about 600° C. The brazing material layers 51 is fused by the heating, and the plate-like fins 5 are brazed to the heat exchange tube 4 by the brazing material layers 51 each of which constitutes the inner peripheral surface of the tubular portion 5b.

As the metal that constitutes the brazing material layer 51, there is used a metal having a melting point lower than those of the metals of the core material layer 52, the sacrificial corrosion layer 53, and the heat exchange tube 4. Therefore, furnace temperature is set to a temperature at which the brazing material layer 51 is fused and the core material layer 52, the sacrificial corrosion layer 53, and the heat exchange tube 4 are not fused during heating using a furnace.

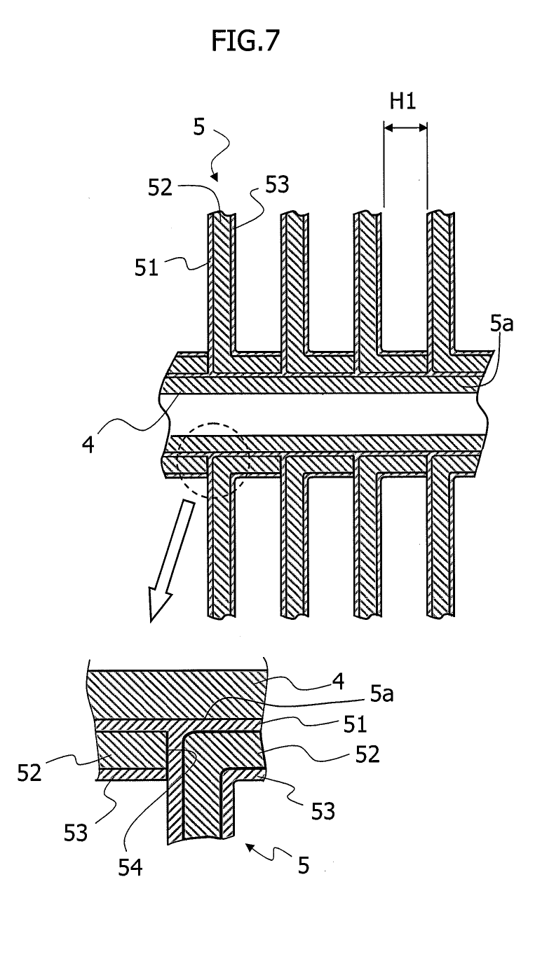

In the assembled body of the plate-like fins 5 and the heat exchange tube 4 before the brazing process, as illustrated in FIG. 6, the adjacent plate-like fins 5 are not in a joined state though they abut the tubular portions 5b. However, when the assembled body is heated using the furnace, the brazing material layers 51, each of which constitutes the inner peripheral surface of the tubular portion 5b, are fused. Therefore, as illustrated in FIG. 7, the brazing material layers 51 of the adjacent tubular portions 5b are integrated, and thus the brazing material layers 51, each of which constitutes the inner peripheral surface of the tubular portion 5b, continuously cover the outer periphery of the heat exchange tube 4.

Moreover, at an abutting portion between the annular end surface 54 of the front end of the tubular portion 5b and the brazing material layer 51 of the adjacent plate-like fin 5, the brazing material layer 51 is fused when the assembled body is heated, and thus the gap at the abutting portion is filled.

According to the heat exchanger 1 described above, the brazing material layers 51 of the plurality of plate-like fins 5 continuously cover the outer periphery of the heat exchange tube 4, and thus a condensate is suppressed from adhering to and corroding the outer surface of the heat exchange tube 4. Therefore, even though the thickness of the heat exchange tube 4 is reduced, leakage of the heat exchange medium may be prevented. In addition, by reducing the thickness of the heat exchange tube 4, heat exchange performance is able to be enhanced.

In addition, the core material layer 52 and the sacrificial corrosion layer 53 are stacked on the outside of the brazing material layer 51 with which the plate-like fin 5 is brazed to the heat exchange tube 4, and thus the sacrificial corrosion layer 53 which is on the outermost side is sacrificially corroded. Therefore, corrosion of the core material layer 52 and the brazing material layer 51 is suppressed.

In addition, since the gap at the abutting portion between the annular end surface 54 of the front end of the tubular portion 5b and the brazing material layer 51 of the adjacent plate-like fin 5 is filled by the fusing of the brazing material layer 51. Therefore, it is possible to suppress a condensate from permeating the brazing material layer 51 that covers the outer periphery of the heat exchange tube 4 from the abutting portion.

Therefore, it is possible to prevent degradation in the adhesion of the plate-like fin 5 to the heat exchange tube 4 due to the corrosion of the brazing material layer 51 with which the plate-like fin 5 is brazed to the heat exchange tube 4.

In addition, at a part from which the brazing material layer 51 and the sacrificial corrosion layer 53 are exposed in a state in which the plate-like fins 5 are stacked at the heat exchange tube 4, the sacrificial corrosion layer 53 is sacrificially corroded, and the brazing material layer 51 is then sacrificially corroded, thereby suppressing the corrosion of the core material layer 52.

Therefore, in a case in which the heat exchanger 1 is used in, for example, a heat pump-type air-conditioner for a vehicle as disclosed in Japanese Laid-Open Patent Publication No. H08-020234, even when a condensate that is generated by a heating operation with heat absorbed by the heat exchanger 1 adheres to the heat exchanger 1, the corrosion of the heat exchange tubes 4 and the core material layers 52 of the plate-like fins 5 may be suppressed, and the adhesion between the heat exchange tubes 4 and the plate-like fins 5 is able to be maintained, thereby maintaining heat exchange performance for a long period of time.

In addition, according to the heat exchanger 1, the heat exchange tubes 4 hold the plate-like fins 5 even before the brazing. Therefore, brazing tools are unnecessary and thus the brazing operation is able to be easily performed.

In addition, in a case of a heat exchanger which uses corrugated fins, a condensate is collected in a trough portion of the corrugated fin and thus sometimes causes corrosion to progress. However, in the heat exchanger 1 using the plate-like fins 5 as described above, drainage characteristics of a condensate are preferable, thus suppressing the progress of corrosion.

In addition, as described above, when the metals that form the heat exchange tube 4 and the layers of the plate-like fin 5 are unified as aluminum-based metals (aluminum Al or aluminum alloys), the heat exchange tube 4 and the layers are subjected to thermal expansion at the same degree during heating for brazing, and thus the occurrence of stress concentration is able to be suppressed.

In addition, there is no need to form a Zn coating on the outer surface of the heat exchange tube 4 subjected to extrusion through spraying or the like in order to enhance the corrosion resistance of the heat exchange tube 4, resulting in a reduction in the cost of the heat exchanger 1.

In this embodiment, the one end surface of the plate-like fin 5 is constituted by the brazing material layer 51, and the other end surface of the plate-like fin 5 is constituted by the sacrificial corrosion layer 53. However, it is possible to cause the plate-like fin 5 to have a double-layer structure of the brazing material layer 51 and the core material layer 52 using a metal (for example, a metal having a corrosion potential higher than that of an Al—Mn based alloy) having a corrosion resistance (spontaneous potential) high enough to have sufficient corrosion resistance as the metal that constitutes the core material layer 52 even though the sacrificial corrosion layer 53 is not included. In this case, one end surface of the plate-like fin 5 is constituted by the brazing material layer 51, the other end surface thereof is constituted by the core material layer 52. Therefore, the inner peripheral surface of the tubular portion 5b is constituted by the brazing material layer 51, by which almost the same operations and effects as those of the embodiment are obtained.

In addition, in the embodiment, the cross-sectional shape of the heat exchange tube 4 is flat. However, a heat exchanger 1 which uses a heat exchange tube 4 having a substantially round cross-sectional shape may be employed. In this case, a through-hole 5a may be a round hole and a tubular portion 5b may have a cylindrical shape. Therefore, the cross-sectional shape of the heat exchange tube 4 is not limited to a flat shape.

In addition, the peripheral edge of the plate-like fin 5 may be coated with a non-corrosive material such as a plastic or a ceramic, or there may be provided a portion in which the sacrificial corrosion layer 53 and the brazing material layer 51 overlap each other in the peripheral edge of the plate-like fin 5.

In addition, the plate-like fin 5 does not need to have a flat shape over the entire surface and, for example, may be provided with a bent portion that constitutes a groove extending in the vertical direction (Y-axis direction) to drain a condensate.

### REFERENCE SIGNS LIST

1 Heat exchanger

2, 3 Header tank

4 Heat exchange tube

5 Plate-like fin

5a Through-hole

5b Tubular portion

51 Brazing material layer

52 Core material layer

53 Sacrificial corrosion layer

1. A heat exchanger comprising:
a heat exchange tube; and
a plate-like fin having a through-hole through which the heat exchange tube passes,
wherein the plate-like fin has a multi-layer structure, including at least a core material layer and a brazing material layer that constitutes one end surface, and has a tubular portion which is raised from a periphery of the through-hole and uses the brazing material layer as an inner peripheral surface, and
wherein a plurality of the plate-like fins which are stacked at the heat exchange tube are joined to the heat exchange tube by brazing with the brazing material layer.

2. The heat exchanger according to claim 1,
wherein the plate-like fin has a multi-layer structure including the core material layer, the brazing material layer, and a sacrificial corrosion layer that constitutes the other end surface.

3. The heat exchanger according to claim 2,
wherein, among the core material layer, the brazing material layer, and the sacrificial corrosion layer which constitute the plate-like fin, a corrosion potential of a metal that forms the sacrificial corrosion layer is the lowest, and a corrosion potential of a metal that forms the core material layer is the highest.

4. The heat exchanger according to claim 2,
wherein the sacrificial corrosion layer is formed of an aluminum-zinc-magnesium Al—Zn—Mg based alloy.

5. The heat exchanger according to claim 1,
wherein the core material layer is formed of an aluminum-manganese Al—Mn based alloy.

6. The heat exchanger according to claim 1,
wherein the brazing material layer is formed of an aluminum-silicon Al—Si based alloy.

7. The heat exchanger according to claim 1,
wherein the heat exchange tube is formed of aluminum Al.

8. The heat exchanger according to claim 1,
wherein the heat exchange tube is formed of aluminum Al to which copper Cu is added.

9. The heat exchanger according to claim 1,
wherein the heat exchange tube is formed of an aluminum-manganese Al—Mn based alloy.

10. The heat exchanger according to claim 1,
wherein the heat exchange tube has a flat cross-sectional shape.

11. A method for producing a heat exchanger which includes an exchange tube and a plate-like fin having a through-hole through which the heat exchange tube passes, the method comprising the steps of:
preparing, as the plate-like fin, a plurality of the plate-like fins, each having a multi-layer structure including at least a core material layer and a brazing material layer that constitutes one end surface and each having a tubular portion which is raised from a periphery of the through-hole and uses the brazing material layer as an inner peripheral surface;
stacking the plurality of the plate-like fins by causing the heat exchange tube to be inserted therethrough so as to cause the tubular portion to cover the heat exchange tube; and
brazing the plurality of the plate-like fins to the heat exchange tube by fusing the brazing material layer.

12. The method for producing a heat exchanger according to claim 11,
wherein the step of preparing the plate-like fins includes a step of forming the tubular portion by a burring process.

13. The method for producing a heat exchanger according to claim 11,
wherein, in the step of preparing the plate-like fins, a plurality of the plate-like fins each having a multi-layer structure including the core material layer, the brazing material layer, and a sacrificial corrosion layer that constitutes the other end surface are prepared.
